(19) United States
(12) Patent Application Publication
(10) Pub. No.: US 2021/0372507 A1
(43) Pub. Date: Dec. 2, 2021

(54) VARIABLE DISPLACEMENT MECHANISM OUTPUT MOVEMENT OF WHICH CAN BE LOWERED TO ZERO STROKE

(71) Applicant: BES ISLETME ARGE VE MUHENDISLIK COZUMLERI SANAYI TICARET LIMITED SIRKETI, Gorukle Nilufer/Bursa (TR)

(72) Inventors: Ahmet SARIGOZ, Bursa (TR); Tahir OCAL, Bursa (TR)

(21) Appl. No.: 16/770,194

(22) PCT Filed: Nov. 12, 2018
(86) PCT No.: PCT/TR2018/050679

§ 371 Date: Jun. 5, 2020

(30) Foreign Application Priority Data
Dec. 8, 2017 (TR) 2017/19954

(51) Int. Cl. F16H 21/20

(52) U.S. Cl. CPC F16H 21/20

(57) ABSTRACT

The invention is about a mechanical system (13), for obtaining variable displacement output movement of which can be lowered to even zero stroke which is driven by input-1 (11) and controlled by input-2 (12), produce variable displacement on ram-1 (6); and it is characterized in that it comprises Eccentric Shaft-1 (1) constrained to the frame by a joint (Y1), actuated by Input-1 (11), and produce force on joint (Y2) on the other end; Connection Rod-1 (2) constrained to said Eccentric Shaft-1 (1) on joint (Y2), and transmits force to joint (Y3) on the other end; Eccentric Shaft-2 (3) constrained to said Connection Rod-1 (2) by a joint (Y3) and constrained to frame by a joint (Y4), and transmits force to guide way bearing (Y6) on the other end; Sliding Pin (4) constrained to said Eccentric Shaft-2 (3) by guide way bearing (Y6), and transmits force on joint (Y5) on the other end; Connection Rod-2 (5) constrained to said Sliding Pin (4) by a joint (Y5), and transmits force on joint (Y9) on the other end; Ram-1 (6) constrained to said second Connection Rod-2 (5) by a joint (Y9)—and constrained to the frame by a guide way bearing (Y10), and outputs motion and force (and/or torque); Ram-2 (8) constrained to the frame by a guide way bearing (Y8), actuated by Input-2 (12), and transmits force on joint (Y7); Connection Rod-3 (7) constrained to said Ram-2 (8) and constrained to said Sliding Pin (4) on the other end by a joint (Y5), and transmits force on joint (Y5); Pin-1 (9) constrained to said Ram-2 (8) and Connection Rod-3 (7) by joint (Y7); and Pin-2 (10) constrained to said Ram-1 (6) and Connection Rod-2 (5) by joint (Y9).

### TECHNICAL FIELD

The invention is about all kinds of machines and mechanical structures which converts input rotary motion to the linear or rotational or any trajectory motion, and produces work through the output path.

### THE PRIOR ART

Reviews of previous techniques which are related to present invention and used in the same applications are as follows:

In the conventional four-bar, slider-crank, and etc. mechanisms; the output stroke is constant, and cannot be changed. If the output stroke path length is subject to be changed, then the mechanism construction members are replaced (or modified) in disassembly-assembly sequences, but again another certain and constant stroke characteristic is obtained. Some equipment are introduced to main mechanism structure, but in this case the construction becomes too complicated, cannot withstand heavy duty applications, and either the stroke length cannot be lowered then a certain minimum limit value.

One another matter, it is very difficult and/or not possible to obtain continuously variable stroke adjustment while mechanism is in process.

One another matter, in some conventional techniques, input motor can be oscillated in back and forth directions in order to change the stroke length of the output, but in this case performance, and service life of the system is sensitively effected. Constant speed motion of the input motor in one direction is very important issue; in order to save the energy and run the motor at maximum performance.

Fundamental two issues for why there is a need, and a trend in the field—for mechanism output movement length which should be closed to zero stroke: Input motor should continuously run at constant speed in one direction. In this way, the motor can be operated at maximum power (torque versus speed) performance. The other issue is an ability to reduce the output stroke path to zero length (or angle). In this way, the output force (or torque) can be increased to very high magnitudes.

Patent research is done for conventional techniques. The patent registration numbers WO2017067561A1, WO2017068910A1, U.S. Pat. No. 7,811,064, RU2613477C1, MX2015011587A, CN105939074A, and CN105443693A are examined. It is determined that, above mentioned requirements cannot be met, and examined patents have no similarity with presented invention.

### DESCRIPTION OF THE INVENTION

The object of the invention is bringing a new initiative in the field, compared to the systems used in conventional techniques.

The object of the invention is containing a kinematic structure which provides output of variable stroke path length, under condition of input movement completing 360 degrees rotation.

Another object of the invention is diminishing the output stroke to zero length (or angle), under condition of input movement completing 360 degrees rotation

Another object of the invention is increasing the output force (or torque) to very high magnitudes under condition of input motion being constant speed rotation.

Another object of the invention is running the input motor at constant speed which refers to optimum performance in terms of torque versus speed.

Another object of the invention is providing smooth motion input to the mechanism while obtaining variable stroke outputs—which make minimum mechanical and/or electrical signal oscillations.

Another object of the invention is being integrated to any system which makes work through a linear stroke—via converting rotary motion (produced by electric motor, manual movement, and etc.) to translational force.

Another object of the present invention is that it has a modular structure.

Another object of the present invention is that it is used standalone in specific application, as well as used as a subsystem of a machine. For example, some of these applications are turret rotation and locking mechanisms; shutter locking mechanisms; squeezing and smashing machinery in food industry; automation lines in health industry; non-woven textile processing lines; woodworking machinery; marble machines; all kind of press fit and compression operations in automotive assembly lines; press brake, shear, punch, drawing presses, blanking presses in sheet metal processing business; cold forging presses; plastic injection presses; rubber injection presses; PVC machines; construction equipment; textile machines; sewing machines; agricultural machinery, fluid pumps, combustion engines, test machines, iso-static powder press machines; and etc.

The object of the invention is about a mechanical system for obtaining variable displacement output movement of which can be lowered to even zero stroke which is driven by an input, and controlled by another input, and which fulfills the above-described purposes such that,

it includes first eccentric shaft constrained to the frame by a joint, first connection rod constrained to said first eccentric shaft by a joint, second eccentric shaft constrained to said first connection rod by a joint, a sliding pin constrained to said second eccentric shaft by guide way bearing, second connection rod constrained to said sliding pin by a joint, first ram constrained to said second connection rod by a joint—and constrained to the frame by a guide way bearing; on the other hand, third connection rod also constrained to said sliding pin by a joint, second ram constrained to said third connection rod by a joint—and constrained to the frame by a guide way bearing, first pin constrained to said second ram—and third connection rod by joints, second pin constrained to said first ram—and second connection rod by joints.

### BRIEF DESCRIPTION OF THE DRAWINGS

FIG. 1: Schematic perspective view of the mechanical system (presented invention)

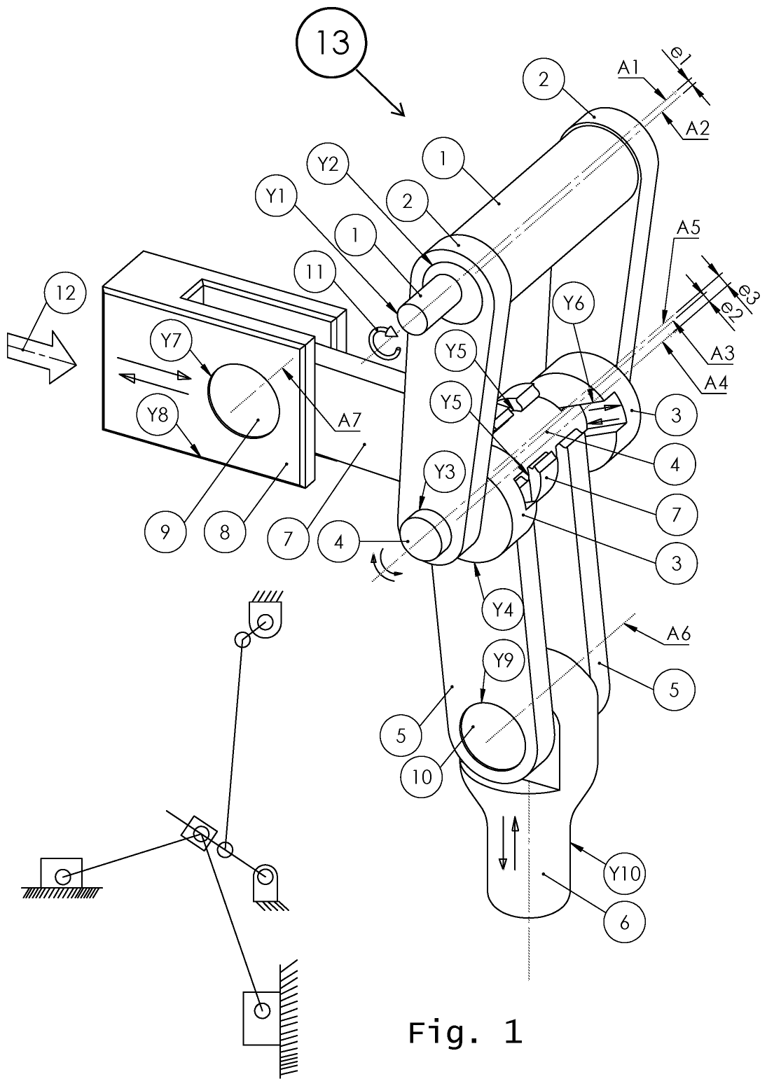

Reference Numbers

| No | Explanation |
|---|---|
| 1 | Eccentric Shaft-1 |
| 2 | Connection Rod-1 |
| 3 | Eccentric Shaft-2 |
| 4 | Sliding Pin |
| 5 | Connection Rod-2 |
| 6 | Ram-1 |
| 7 | Connection Rod-3 |
| 8 | Ram-2 |
| 9 | Pin-1 |
| 10 | Pin-2 |
| 11 | Input-1 |
| 12 | Input-2 |
| 13 | Variable Displacement Mechanism Output Movement of Which |
| | Can Be Lowered to Zero Stroke (SSDDM) |
| Y1 | Joint of Eccentric Shaft-1 on frame |
| Y2 | Joint of Connection Rod-1 on Eccentric Shaft-1 |
| Y3 | Joint of Eccentric Shaft-2 on Connection Rod-1 |
| Y4 | Joint of Eccentric Shaft-2 on frame |
| Y5 | Joint of Sliding Pin on Connection Rod-2 and Connection Rod-3 |
| Y6 | guide way bearing of Sliding Pin on Eccentric Shaft-2 |
| Y7 | Joint of Pin-1 on Ram-2 |
| Y8 | Guide way bearing of Ram-2 on frame |
| Y9 | Joint of Pin-2 on Ram-1 |
| Y10 | Guide way bearing of Ram-1 on frame |
| A1 | Axis of joint Y1 |
| A2 | Axis of joint Y2 |
| A3 | Axis of joint Y3 |
| A4 | Axis of joint Y4 |
| A5 | Axis of joint Y5 |
| A5 | Axis of joint Y9 |
| A7 | Axis of joint Y7 |
| e1 | Distance between axis A1 and A2 (measure of eccentricity-1) |
| e2 | Distance between axis A3 and A4 (measure of eccentricity-2) |
| e3 | Distance between axis A4 and A5 (measure of eccentricity-3) |

### DETAILED DESCRIPTION OF THE INVENTION

The invention is about a mechanical system (13), which is driven by input-1 (11) and controlled by input-2 (12), produce variable displacement on ram-1 (6) such that this output displacement can even be reduced to zero; and it is characterized in that it comprises Eccentric Shaft-1 (1) constrained to the frame by a joint (Y1), actuated by Input-1 (11), and transmits force on joint (Y2) on the other end; Connection Rod-1 (2) constrained to said Eccentric Shaft-1 (1) on joint (Y2), and transmits force to joint (Y3) on the other end; Eccentric Shaft-2 (3) constrained to said Connection Rod-1 (2) by a joint (Y3) and constrained to frame by a joint (Y4), and transmits force to guide way bearing (Y6) on the other end; Sliding Pin (4) constrained to said Eccentric Shaft-2 (3) by guide way bearing (Y6), and transmits force on joint (Y5) on the other end; Connection Rod-2 (5) constrained to said Sliding Pin (4) by a joint (Y5), and transmits force on joint (Y9) on the other end; Ram-1 (6) constrained to said second Connection Rod-2 (5) by a joint (Y9)—and constrained to the frame by a guide way bearing (Y10), and outputs motion and force (and/or torque); Ram-2 (8) constrained to the frame by a guide way bearing (Y8), actuated by Input-2 (12), and transmits force on joint (Y7); Connection Rod-3 (7) constrained to said Ram-2 (8) by a joint (Y7) and constrained to said Sliding Pin (4) on the other end by a joint (Y5), and transmits force on joint (Y5); Pin-1 (9) constrained to said Ram-2 (8) and Connection Rod-3 (7) by joint (Y7); and Pin-2 (10) constrained to said Ram-1 (6) and Connection Rod-2 (5) by joint (Y9).

Torque supplied by Input-1 (11) via manual or motor or any input means is transferred to Eccentric Shaft-1 (1). Eccentric Shaft-1 (1) is free to turn 360 degrees. Force transmitted through Connection Rod-1 (2) is converted to torque on Eccentric Shaft-2 (3). Eccentric Shaft-2 (3) oscillates back and forth in angular motion. The oscillation range of Eccentric Shaft-2 (3) is defined by appropriate determination of variables of the distance between axis A1 and A2 (measure of eccentricity-1) (e1), the distance between axis A1 and A3, and the distance between axis A3 and A4 (measure of eccentricity-2) (e2).

The distance between axis A4 and A5 (measure of eccentricity-3) (e3) is determined by the distance between axis A5 and A7 (length of Connection Rod-3 (7)), and the location of Axis A7 on Ram-2 (8) which is determined by Input-2 (12). Thus, measure of eccentricity-3 (e3) is determined by force supplied by Input-2 (12) via manual or motor or any input means, and transferred to Ram-2 (8).

As axis A5 come close to axis A4 through guide way bearing (Y6), the distance in between (measure of eccentricity-3 (e3)) can be even reduced to zero.

The torque on Eccentric Shaft-2 (3) is converted to force on Sliding Pin (4), thanks to the distance between axis A4 and A5 (measure of eccentricity-3) (e3).

Converted force on Sliding Pin (4) depends on measure of eccentricity-3 (e3); and when “e3” approaches to zero, the magnitude of this force goes to infinity.

Sliding Pin (4) oscillates back and forth in angular motion in accordance with Eccentric Shaft-2 (3). The magnitude of oscillation depends on the measure of eccentricity-3 (e3) which is determined by Input-2 (12) as explained above; and when “e3” approaches to zero, the magnitude of this oscillation goes to zero.

Besides, measure of eccentricity-3 (e3) changes slightly when Eccentric Shaft-2 (3) oscillates. When Eccentric Shaft-2 (3) oscillates the change measure of eccentricity-3 (e3) can be kept negligible by appropriate determination of length of mechanism members and distances between axis Y1 and axis Y3.

Force on Sliding Pin (4) is transmitted to Ram-1 (6) through Connection Rod-2 (5), and force or torque or any combination of these two is obtained as an output depending on the structure of path of Guide way bearing of Ram-1 on frame (Y10). It is clear that when the measure of eccentricity-3 (e3) is closed to zero, the magnitude of output displacement of Ram-1 (6) gets close to zero, and the magnitude of force (and/or torque) output of Ram-1 (6) goes to infinity.

Alternative Applications

Input-2 (12) can be exerted on Ram-1 (6), thus, above described output displacement and force (and/or torque) can be obtained on Ram-2 (8).

Input-2 (12) can be exerted on Eccentric Shaft-1 (1), thus, above described output displacement and force (and/or torque) can be obtained on Ram-1 (6) and/or Ram-2 (8).

Input-1 (11) and Input-2 (12) can be exerted Ram-1 (6) and Ram-2 (8) respectively, or vice or versa, thus output can be obtained on Eccentric Shaft-1 (1) required that Input-1 (11) is appropriate with the structure of guide way bearings Y8 or Y10.

A link(s) with revolute joints in both ends can be replaced with one or two of Ram-1 (6) or Ram-2 (8), required that said link(s) is (are) constrained to the frame by joint(s) in one end(s) and constrained to the Connection Rod-2 (5) and/or Connection Rod-3 (7) by joint(s) on the other end(s).

The shape of trajectory of guide ways Y8 or Y10 can be straight line or pure circular arc or spline of any mathematical function.

Input-1 (11) can be of constant or varying speed and/or torque in the course of mechanism working. The input power can be constant or varying in the course of mechanism working.

Motion range of Input-1 (11) can be smaller than one tour (360 degrees).

Motion and/or torque of Input-1 (11) can be oscillatory.

1. A mechanical system (13), which is driven by input-1 (11), controlled by input-2 (12), and produce variable displacement on ram-1 (6) such that this output displacement can even be reduced to zero, the mechanical system comprising:
an Eccentric Shaft-1 (1) constrained to the frame by a joint (Y1), and produce force on joint (Y2) on the other end;
a Connection Rod-1 (2) constrained to said Eccentric Shaft-1 (1) on joint (Y2), and transmits force to joint (Y3) on the other end;
an Eccentric Shaft-2 (3) constrained to said Connection Rod-1 (2) by a joint (Y3) and constrained to frame by a joint (Y4), and transmits force to guide way bearing (Y6) on the other end;
a Sliding Pin (4) constrained to said Eccentric Shaft-2 (3) by guide way bearing (Y6), and transmits force on joint (Y5) on the other end;
a Connection Rod-2 (5) constrained to said Sliding Pin (4) by a joint (Y5), and transmits farce on joint (Y9) on the other end;
a Ram-1 (6) constrained to said second Connection Rod-2 (5) by a joint (Y9)—and constrained to the frame by a guide way bearing (Y10);
a Ram-2 (8) constrained to the frame by a guide way bearing (Y8), and transmits force on joint (Y7);
a Connection Rod-3 (7) constrained to said Ram-2 (8) and constrained to said Sliding Pin (4) on the other end by a joint (Y5), and transmits force on joint (Y5):
a Pin-1 (9) constrained to said Ram-2 (8) and Connection Rod-3 (7) by joint (Y7);
a Pin-2 (13) constrained to said Ram-1 (6) and Connection Rod-2 (5) by joint (Y9).
an Input-1 (11) exerted on Eccentric Shaft-1 (1), or Ram-1 (6), or Ram-2 (8).
an Input-2 (12) exerted on Eccentric Shaft-1 (1), or Ram-1 (6), or Ram-2 (8).

2. The mechanical system (13) according to claim-1, characterized in that;
Input-1 (11) is transferred to Eccentric Shaft-1 (1).
Input-2 (12) is transferred to Ram-2 (8).

3. The mechanical system (13) according to claim-1, characterized in that, said Input-1 (11) and Input-2 (12) devices are manual or motor or mechanical or electric-electronic or hydraulic/pneumatic or magnetic or piezo-electric based elements or any means.

4. The mechanical system (13) according to claim-1, characterized in that: the shape of trajectory of guide ways Y8 or Y10 can be straight line or pure circular arc or spline of any mathematical function.

5. The mechanical system (13) according to claim-1, characterized in that, linear motion or angular motion or any combination of these two, as well as force or torque or any combination of these two is obtained as an output depending on the structure of path of Guide way bearing of Ram-1 (6) on frame (Y10).

6. The mechanical system (13) according to claim-1, characterized in that; a link with revolute joints in both ends can be replaced with Ram-1 (6) required that said link is constrained to the frame by joint in one end and constrained to the Connection Rod-2 (5) by joint on the other end.

7. The mechanical system (13) according to claim-1, characterized in that; a link with revolute joints in both ends can be replaced with Ram-2 (8) required that said link is constrained to the frame by joint in one end and constrained to the Connection Rod-3 (7) by joint on the other end.

8. A method of obtaining variable displacement output movement of which can be even lowered to zero stroke, and variable force (and/or torque) which can be even increased to infinity, characterized in that;
Eccentric Shaft-1 (1) turns more than 360 degrees:
Eccentric Shaft-2 (3) oscillates back and forth in angular motion,
the distance between axis A4 and A5 (measure of eccentricity-3) (e3) is determined by the distance between axis A5 and A7 (length of Connection Rod-3 (7)), and the location of Axis A7 on Ram-2 (8) which is determined by Input-2 (12).
measure of eccentricity-3 (e3) is determined by Input-2 (12) transferred to Ram-2 (8).
as axis AS come close to axis A4 through guide way bearing (Y6), the distance in between (measure of eccentricity-3 (e3)) can be even reduced to zero.

9. The method according to claim-8, characterized in that, sliding Pin (4) oscillates back and forth in angular motion in accordance with Eccentric Shaft-2 (3). The magnitude of oscillation depends on the measure of eccentricity-3 (e3), and as ‘e3” approaches to zero, the magnitude of this oscillation goes to zero

10. The method according to claim-8 and characterized in that; Input-2 (12) can be exerted on Ram-1 (6), thus, above described output displacement and force (and/or torque) can be obtained on Ram-2 (8).

11. The method according to claim-8 characterized in that, Input-2 (12) can be exerted on Eccentric Shaft-1 (1), thus, above described output displacement and force (and/or torque) can be obtained on Ram-1 (6) and/or Ram-2 (8).

12. The method according to claim-8 characterized in that Input-1 (11) and Input-2 (12) can be exerted Ram-1 (6) and Ram-2 (8) respectively, or vice or versa, thus output can be obtained on Eccentric Shaft-1 (1) required that Input-1 (11) is appropriate with the structure of guide way bearings Y8 or Y10.

13. The method according to claim-8 characterized in that, Input-1 (11) can be of constant or varying speed and/or torque in the course of mechanism working. The input power can be constant or varying in the course of mechanism working.

14. The method according to claim-8 characterized in that, motion range of Input-1 (11) can be smaller than one tour (360 degrees).

15. The method according to claim-8 characterized in that, motion and/or torque of Input-1 (11) can be oscillatory.
